(19) United States
(12) Patent Application Publication
(10) Pub. No.: US 2026/0091698 A1
(43) Pub. Date: Apr. 2, 2026

(54) PURLIN-LESS HOISTING-TYPE BIFACIAL POWER-GENERATION INTEGRATED CANOPY

(71) Applicant: ANHUI CAESAR NEW ENERGY TECHNOLOGY CO.,LTD, Chuzhou (CN)

(72) Inventors: Xiaofeng Huang, Chuzhou (CN); Siping Xie, Chuzhou (CN)

(21) Appl. No.: 19/411,432

(22) Filed: Dec. 8, 2025

(30) Foreign Application Priority Data
Sep. 29, 2025 (CN) 202511404145.2

(51) Int. Cl. B60L 53/30; B60L 53/51; E04H 6/02

(52) U.S. Cl. CPC B60L 53/30; B60L 53/51; E04H 6/025

(57) ABSTRACT

A purlin-less hoisting-type bifacial power-generation integrated canopy includes a supporting and fixing mechanism of a bifacial splayed structure as a whole to be conveniently hoisted during assembly, having a first hoisting mode for integral hoisting and a second hoisting mode for partial hoisting; and a charging and power generation integrated mechanism used to generate electricity by using solar energy during operation and then supply the electricity for vehicle charging. In the first hoisting mode of the supporting and fixing mechanism, the photovoltaic panels of the charging and power generation integrated mechanism and the fixing structure on the supporting and fixing mechanism for being pre-assembled with the photovoltaic panels are integrally hoisted; and in the second hoisting mode of the supporting and fixing mechanism, the photovoltaic panels and the fixing structure are hoisted partially.

### CROSS REFERENCE TO RELATED APPLICATIONS

The present disclosure claims the priority to the Chinese patent application with the filing No. 2025114041452, entitled “PURLIN-LESS HOISTING-TYPE BIFACIAL POWER-GENERATION INTEGRATED CANOPY” and filed on September 29, 2025 with the Chinese Patent Office, the contents of which are incorporated herein by reference in their entirety.

### TECHNICAL FIELD

The present disclosure relates to the technical field of new energy vehicle canopy, and particularly to a purlin-less hoisting-type bifacial power-generation integrated canopy.

### BACKGROUND ART

In recent years, new energy vehicles of our country have experienced explosive growth, leading to a surge in charging demand. As a result, charging canopies have become ubiquitous in some large and medium-sized cities. Among them, the power supply of traditional charging canopies mainly relies on the power supply from the national power grid, and with the development of new energy, solar energy generation integrated canopies have gradually become popular.

During the assembly process of current power-generation integrated canopies, it is necessary to first complete the installation of the overall supporting and fixing structure of the canopy before installing the photovoltaic assemblies on the purlins. During this process, both the fixing structure and the photovoltaic assemblies of the canopy require a long period of aerial operation, which greatly consumes the physical strength of installation workers and thus poses potential safety hazards in construction. Meanwhile, the assembly may only be carried out step by step in the air on-site during installation, with no possibility of pre-installation in advance, therefore resulting in a relatively low efficiency during installation of existing new energy power generation integrated canopies.

### SUMMARY

The purpose of this section is to outline some aspects of the embodiments of the present disclosure and to briefly describe some preferred embodiments. Simplifications or omissions may be made in this section, as well as in abstract of the specification and title of the present disclosure, to avoid obscuring the purpose of this section, as well as the abstract of the specification and title of the present disclosure; and however, such simplifications or omissions should not be construed as limiting the scope of the present disclosure.

Therefore, the purpose of the present disclosure is to provide a purlin-less hoisting-type bifacial power-generation integrated canopy, which replaces the installation manner of traditional new energy power generation integrated canopies, avoiding the problems of high potential construction safety hazards during installation and low efficiency in the installation process.

To address the above-mentioned technical problems, according to one aspect of the present disclosure, the present disclosure provides the following technical solutions.

A purlin-less hoisting-type bifacial power-generation integrated canopy includes:

a supporting and fixing mechanism, which is of a bifacial splayed structure as a whole, to be conveniently hoisted during assembly, where the supporting and fixing mechanism has a first hoisting mode for integral hoisting and a second hoisting mode for partial hoisting; and

a charging and power generation integrated mechanism, which is configured to generate electricity by using solar energy during operation and then supply the electricity for vehicle charging, where in the first hoisting mode of the supporting and fixing mechanism, the photovoltaic panels of the charging and power generation integrated mechanism and the fixing structure on the supporting and fixing mechanism for being pre-assembled with the photovoltaic panels are integrally hoisted; and in the second hoisting mode of the supporting and fixing mechanism, the photovoltaic panels of the charging and power generation integrated mechanism and the fixing structure on the supporting and fixing mechanism for being pre-assembled with the photovoltaic panels are hoisted partially.

As a preferred embodiment of the purlin-less hoisting-type bifacial power-generation integrated canopy described in the present disclosure, in the above, the supporting and fixing mechanism includes a supporting assembly and multiple fixing assemblies installed on the supporting assembly for easy pre-installation of the photovoltaic panels.

As a preferred embodiment of the purlin-less hoisting-type bifacial power-generation integrated canopy described in the present disclosure, in the above, the supporting assembly includes upright columns fixed at the four corners of the installation site, inter-column longitudinal beams each installed between corresponding two front and rear upright columns, and inter-column cross beams each connected between corresponding two left and right upright columns.

As a preferred embodiment of the purlin-less hoisting-type bifacial power-generation integrated canopy described in the present disclosure, in the above, the top of each upright column is provided with a bearing plate having a top provided with multiple adjustment holes.

As a preferred embodiment of the purlin-less hoisting-type bifacial power-generation integrated canopy described in the present disclosure, in the above, the fixing assembly includes a fixing beam assembly installed between the two inter-column cross beams, a fixing inclined beam assembly located on the two sides of the fixing beam assembly and being of a splayed structure, and a connecting beam for reinforcing the fixing beam assembly.

As a preferred embodiment of the purlin-less hoisting-type bifacial power-generation integrated canopy described in the present disclosure, in the above, the fixing beam assembly includes a first fixing beam installed between the two inter-column cross beams and a second fixing beam connected to the fixing inclined beam assembly.

The fixing inclined beam assembly includes a first fixing inclined beam and a second fixing inclined beam, which are respectively installed on the two sides of each of the first fixing beam and the second fixing beam and are of a splayed structure.

The two ends of the connecting beam are each provided with a connecting bracket having side walls provided with fixing holes.

In the above, the first fixing inclined beam and the second fixing inclined beam each have a cross-section of a U-shaped structure, and the first fixing beam and the second fixing beam are each of a square tubular structure.

As a preferred embodiment of the purlin-less hoisting-type bifacial power-generation integrated canopy described in the present disclosure, in the above, the supporting and fixing mechanism further includes reinforcing assemblies configured for reinforcing the multiple fixing assemblies.

The reinforcing assembly includes two reinforcing beams installed between two adjacent connecting beams and arranged in a crossed configuration.

As a preferred embodiment of the purlin-less hoisting-type bifacial power-generation integrated canopy described in the present disclosure, in the above, one of the upright columns has one side wall provided with a mounting bracket.

The charging and power generation integrated mechanism includes photovoltaic assemblies installed on the first fixing inclined beams and the second fixing inclined beams, an inverter installed on the mounting bracket and electrically connected to the photovoltaic assemblies, an energy storage cabinet located on one side of the supporting and fixing mechanism and electrically connected to the inverter, and charging piles electrically connected to the energy storage cabinet and the inverter.

In the above, each two adjacent fixing assemblies and the photovoltaic assemblies installed on the two sides thereof constitute a charging parking space, and each charging pile corresponds to one or two charging parking spaces.

As a preferred embodiment of the purlin-less hoisting-type bifacial power-generation integrated canopy described in the present disclosure, in the above, it further includes a waterproof diversion mechanism, where the waterproof diversion mechanism includes a top waterproof plate located on the top of the photovoltaic assemblies in a splayed structure, transverse waterproof plates installed between two adjacent upper and lower photovoltaic assemblies, and longitudinal waterproof plates installed between the two adjacent left and right photovoltaic assemblies.

As a preferred embodiment of the purlin-less hoisting-type bifacial power-generation integrated canopy described in the present disclosure, in the above, the transverse and longitudinal gaps of the photovoltaic assemblies are set to be consistent, the cross-sections of the transverse waterproof plates and the longitudinal waterproof plates are of the same specification, and the cross-sections of the transverse waterproof plates and the longitudinal waterproof plates are provided with barbed structures adapted to the open cross-sections of the steel frames of the photovoltaic assemblies.

Compared with the prior art, the present disclosure has the following beneficial effects: the purlin-less hoisting-type bifacial power-generation integrated canopy allows for easy hoisting of the supporting and fixing mechanism during the installation of the canopy, thereby reducing the time for aerial operations of workers. Meanwhile, the stability of the splayed structure allows the fixing structure of the supporting and fixing mechanism for securing the photovoltaic panels and the corresponding photovoltaic panels to be integrally hoisted in the first hoisting mode of the supporting and fixing mechanism, thereby greatly improving installation efficiency; and pre-installation of the fixing structure and photovoltaic panels in advance further reduces on-site work time. In the second hoisting mode of the supporting and fixing mechanism, the fixing structure of the supporting and fixing mechanism for securing photovoltaic panels and the corresponding photovoltaic panels can be partially hoisted, thereby facilitating immediate adjustment of the number of photovoltaic panels according to the size of the canopy. Thus, the two hoisting modes facilitate the flexible size adjustment and assembly of the canopy; and the charging and power generation integrated mechanism generates electricity by using solar energy during operation to supply the electricity for vehicle charging, replacing the installation manner of traditional new energy power generation integrated canopies and avoiding the problems of high potential construction safety hazards during installation and low efficiency in the installation process simultaneously.

### BRIEF DESCRIPTION OF DRAWINGS

In order to more clearly illustrate the technical solutions in the embodiments of the present disclosure, the present disclosure will be described in detail below with reference to the drawings and detailed embodiments. Obviously, the drawings described below are only some embodiments of the present disclosure. For a person ordinarily skilled in the art, other drawings may be obtained based on the provided drawings without paying creative work. In the above,

FIG. 1 is a structural schematic view of a purlin-less hoisting-type bifacial power-generation integrated canopy according to the present disclosure;

FIG. 2 is a structural schematic view of the supporting and fixing mechanism of the purlin-less hoisting-type bifacial power-generation integrated canopy according to the present disclosure;

FIG. 3 is a front view of the supporting and fixing mechanism of the purlin-less hoisting-type bifacial power-generation integrated canopy according to the present disclosure;

FIG. 4 is an enlarged view of part A in FIG. 2 of the purlin-less hoisting-type bifacial power-generation integrated canopy according to the present disclosure;

FIG. 5 is a structural schematic view of the fixing assembly of the purlin-less hoisting-type bifacial power-generation integrated canopy according to the present disclosure;

FIG. 6 is a structural exploded view of the fixing assembly of the purlin-less hoisting-type bifacial power-generation integrated canopy according to the present disclosure;

FIG. 7 is a structural schematic view of the supporting and fixing mechanism of the purlin-less hoisting-type bifacial power-generation integrated canopy according to the present disclosure in the first hoisting mode;

FIG. 8 is a structural schematic view of the supporting and fixing mechanism of the purlin-less hoisting-type bifacial power-generation integrated canopy according to the present disclosure in the second hoisting mode;

FIG. 9 is a cross-sectional view of the transverse waterproof plate being connected to the steel frames of the photovoltaic assemblies of the purlin-less hoisting-type bifacial power-generation integrated canopy according to the present disclosure; and

FIG. 10 is a structural schematic view of the transverse waterproof plate and longitudinal waterproof plate of the purlin-less hoisting-type bifacial power-generation integrated canopy according to the present disclosure.

In the figures: 100, supporting and fixing mechanism; 110, supporting assembly; 110a, upright column; 110a-1, bearing plate; 110a-11, adjustment hole; 110a-2, mounting bracket; 110b, inter-column longitudinal beam; 110c, inter-column cross beam; 120, fixing assembly; 120a, fixing beam assembly; 120a-1, first fixing beam; 120a-2, second fixing beam; 120b, fixing inclined beam assembly; 120b-1, first fixing inclined beam; 120b-2, second fixing inclined beam; 120c, connecting beam; 120c-1, connecting bracket; 130, reinforcing assembly; 130a, reinforcing beam; 140, charging parking space; 200, charging and power generation integrated mechanism; 210, photovoltaic assembly; 210a, steel frame; 220, inverter; 230, energy storage cabinet; 240, charging pile; 300, waterproof diversion mechanism; 310, top waterproof plate; 320, transverse waterproof plate; and 330, longitudinal waterproof plate.

### DETAILED DESCRIPTION OF EMBODIMENTS

To make the above-mentioned purposes, features and advantages of the present disclosure more apparent and understandable, the specific embodiments of the present disclosure will be described in detail below with reference to the drawings.

Secondly, the present disclosure is described in detail with reference to the schematic views. When detailing the embodiments of the present disclosure, for ease of explanation, the cross-sectional views illustrating the device structure may be partially enlarged without following the usual scale, and the schematic views are merely examples and should not limit the scope of protection of the present disclosure.

In addition, three-dimensional spatial dimensions of length, width, and depth should be included in actual fabrication.

To make the purposes, technical solutions, and advantages of the present disclosure clearer, the embodiments of the present disclosure will be described in further detail below with reference to the drawings.

The present disclosure provides a purlin-less hoisting-type bifacial power-generation integrated canopy, which replaces the installation manner of traditional new energy power generation integrated canopies, avoiding the problems of high potential construction safety hazards during installation and low efficiency in the installation process.

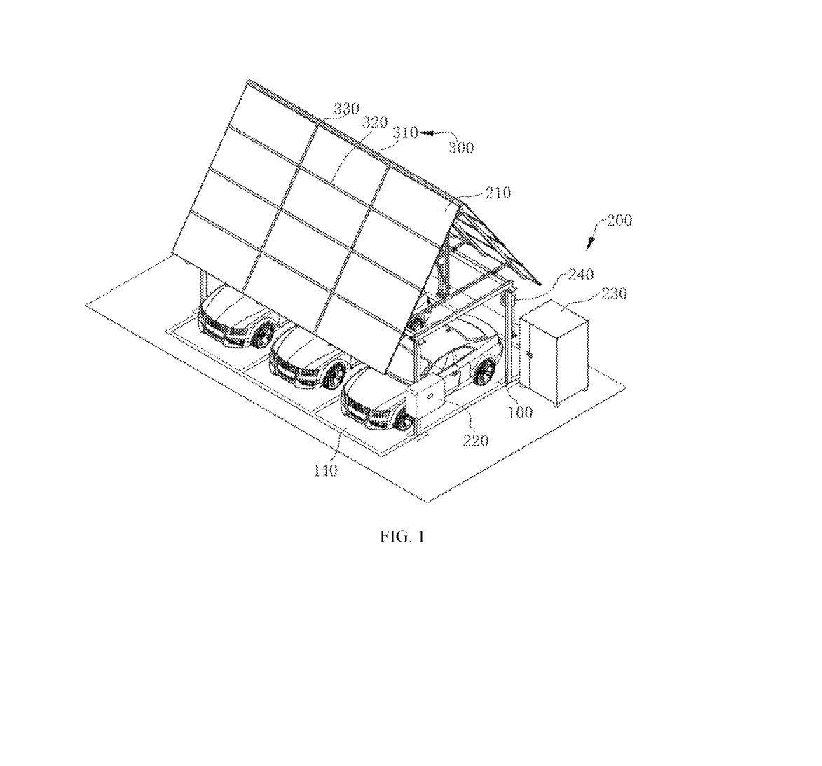

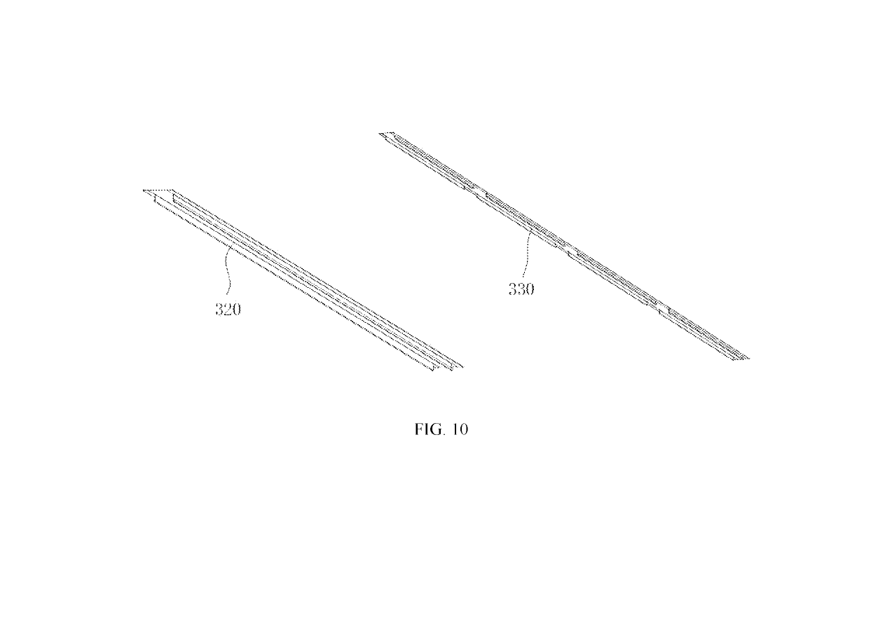

FIG. 1-FIG. 10 show structural schematic views of a purlin-less hoisting-type bifacial power-generation integrated canopy according to the present disclosure. Reference is made to FIG. 1- FIG. 10 for detailed introduction of the purlin-less hoisting-type bifacial power-generation integrated canopy.

### Example 1

Referring to FIG. 1-FIG. 8, the present disclosure discloses a purlin-less hoisting-type bifacial power-generation integrated canopy, the main body of which includes a supporting and fixing mechanism 100 and a charging and power generation integrated mechanism 200.

Referring to FIG. 1-FIG. 3, the supporting and fixing mechanism 100 is used to fix and support the charging and power generation integrated mechanism 200. The supporting and fixing mechanism 100 is of a bifacial splayed structure to be conveniently hoisted during assembly. The bifacial splayed mechanism of the supporting and fixing mechanism 100 is more stable than the existing planar structure. Meanwhile, the bifacial structure can increase the power generation area, thereby increasing the utilization rate of solar energy. Meanwhile, the supporting and fixing mechanism 100 is convenient for hoisting during assembly, so that the power generation panels of the charging and power generation integrated mechanism 200 may be pre-installed on the fixing structure and then directly hoisted, thereby reducing the assembling time in the air and reducing construction safety hazards. In the above, the supporting and fixing mechanism 100 has a first hoisting mode for integral hoisting and a second hoisting mode for partial hoisting, such that when the supporting and fixing mechanism 100 is in the first hoisting mode, it is convenient to hoist the entire fixing structure and photovoltaic panels which are pre-installed, thereby reducing the time of aerial operations; and when the supporting and fixing mechanism 100 is in the second hoisting mode, the fixing structure and photovoltaic panels are partially hoisted, which not only reduces the time of aerial operations in one aspect, but also allows real-time adjustment of the assembly quantity of the photovoltaic panels according to the size of the canopy.

Referring to FIG. 1, the charging and power generation integrated mechanism 200 is used to generate electricity by using solar energy, then store the electrical energy, and supply the electricity for vehicle charging. The charging and power generation integrated mechanism 200 is used to generates electricity during operation by using solar energy and then supply the electricity for vehicle charging. In the above, in the first hoisting mode of the supporting and fixing mechanism 100, the photovoltaic panels of the charging and power generation integrated mechanism 200 and the fixing structure on the supporting and fixing mechanism 100 for being pre-assembled with the photovoltaic panels are integrally hoisted; and in the second hoisting mode of the supporting and fixing mechanism 100, the photovoltaic panels of the charging and power generation integrated mechanism 200 and the fixing structure on the supporting and fixing mechanism 100 for being pre-assembled with the photovoltaic panels are partially hoisted. Thus, in the first hoisting mode of the supporting and fixing mechanism 100, the pre-installed photovoltaic assemblies 210 and the fixing structure are integrally hoisted; and in the second hoisting mode, the partially pre-installed photovoltaic panels and the fixing structure are hoisted, therefore reducing on-site operation time and simultaneously reducing aerial operation time through the pre-installation in advance.

In this example, the specific usage process is as follows. First, the photovoltaic panels and the fixing structure which are to be installed are pre-installed according to the size of the canopy. Under the condition that the hoisting load-bearing capacity permits, the supporting and fixing mechanism 100 is in the first hoisting mode, and is integrally hoisted after the photovoltaic panels and the fixing structure are pre-installed as a whole, thereby reducing the procedures and time of aerial operations. Under the condition of limited hoisting load-bearing capacity or when needing to separately hoist partial photovoltaic panels, the supporting and fixing mechanism 100 is in the second hoisting mode, and the partially pre-installed photovoltaic panels and the fixing structure are hoisted. Thus, the supporting and fixing mechanism 100 can be flexibly adjusted between the first hoisting mode and the second hoisting mode according to on-site installation requirements and hoisting capacity, reducing potential safety hazards in on-site construction. Meanwhile, the on-site construction efficiency is improved by the manner of pre-installing the photovoltaic panels on the fixing structure in advance and performing hoisting to reduce the time of aerial operations.

### Example 2

On the basis of Example 1, referring to FIG. 1-FIG. 6, the supporting and fixing mechanism 100 includes a supporting assembly 110 and multiple fixing assemblies 120 installed on the supporting assembly 110 for easy pre-installation of photovoltaic panels. The supporting assembly 110 is used to support the fixing assemblies 120 and the charging and power generation integrated mechanism 200, and the multiple fixing assemblies 120 are used to install and fix the multiple photovoltaic panels.

In the present example, referring to FIG. 1-FIG. 4, the supporting assembly 110 includes upright columns 110a fixed at the four corners of the installation site, inter-column longitudinal beams 110b each installed between the corresponding two front and rear upright columns 110a, and inter-column cross beams 110c connected between the corresponding two left and right upright columns 110a, where the upright columns 110a serve to provide the function of supporting the inter-column longitudinal beams 110b and the inter-column cross beams 110c, and moreover, are fixed at the four corners of the installation site to form stable bottom support, the inter-column longitudinal beam 110b is used to connect and reinforce the front and rear two upright columns 110a, the inter-column cross beam 110c is used to connect and reinforce the left and right two upright columns 110a, and they also facilitate the installation of the multiple fixing assemblies 120.

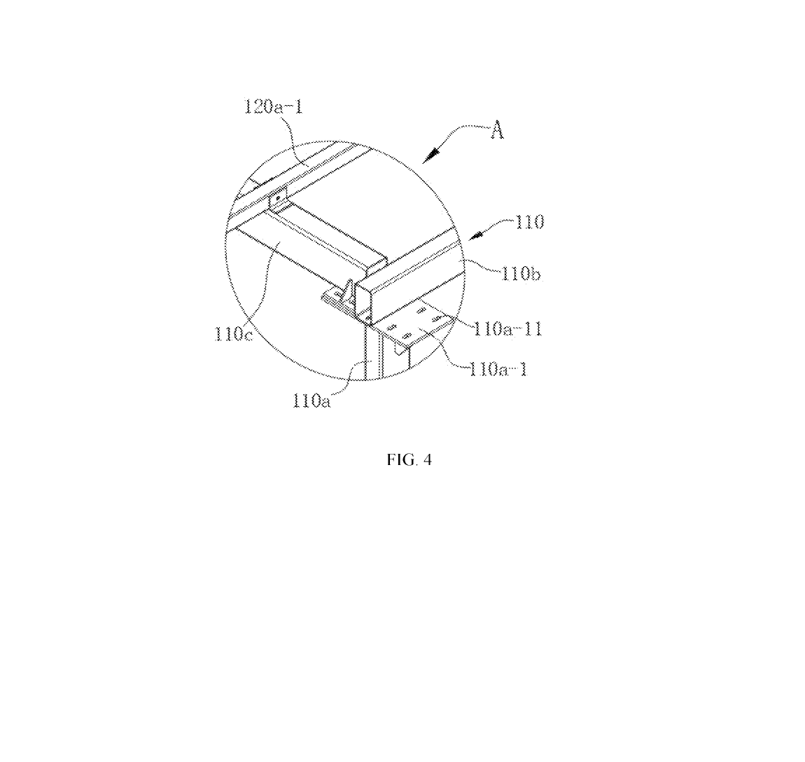

In the present example, referring to FIG. 4, the top of the upright column 110a is provided with a bearing plate 110a-1 having the top provided with multiple adjustment holes 110a-11, where the bearing plate 110a-1 is used to facilitate bearing of the inter-column cross beam 110c and the inter-column longitudinal beam 110b, and the adjustment holes 110a-11 are used to facilitate the adjustment of the positions of the inter-column cross beam 110c and the inter-column longitudinal beam 110b during the installation process.

In the present example, referring to FIG. 1-FIG. 6, the fixing assembly 120 includes a fixing beam assembly 120a installed between two inter-column cross beams 110c, a fixing inclined beam assembly 120b located on the two sides of the fixing beam assembly 120a and being of a splayed structure, and a connecting beam 120c for reinforcing the fixing beam assembly 120a, where the fixing beam assembly 120a is used to facilitate fixing and supporting of the fixing inclined beam assembly 120b, the fixing inclined beam assembly 120b is used to fix and install the photovoltaic panels, the splayed structure of the fixing inclined beam assembly 120b is used to make the installed photovoltaic panels in a splayed shape, thereby improving the overall wind resistance, and meanwhile, the splayed structure facilitates the sliding off of accumulated dust, accumulated snow and other debris on the surfaces of the photovoltaic panels, thereby avoiding their impact on the power generation efficiency of the photovoltaic panels, and the connecting beam 120c is used to reinforce the fixing beam assembly 120a, thereby improving the structural stability of the entire fixing assembly 120.

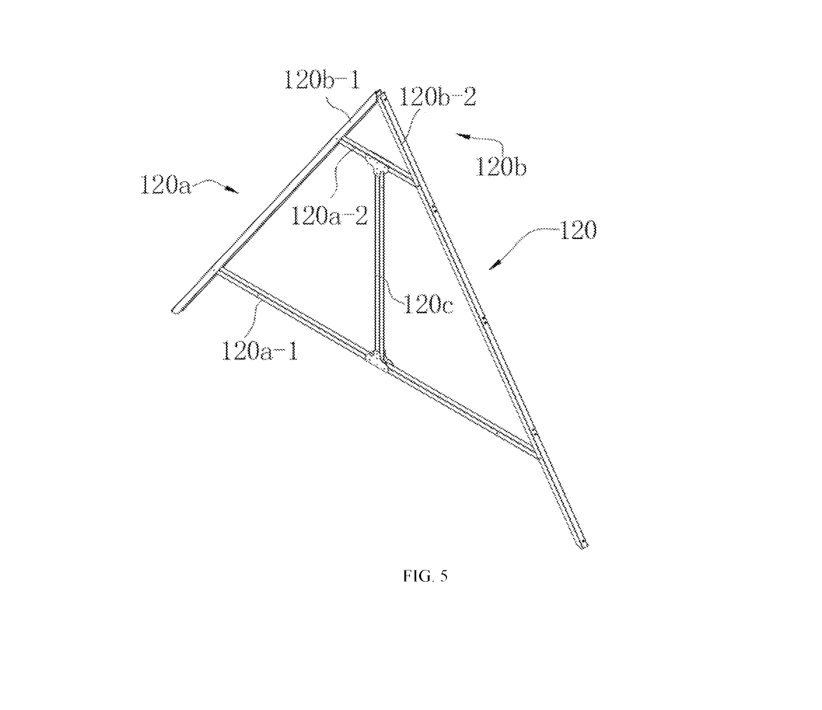

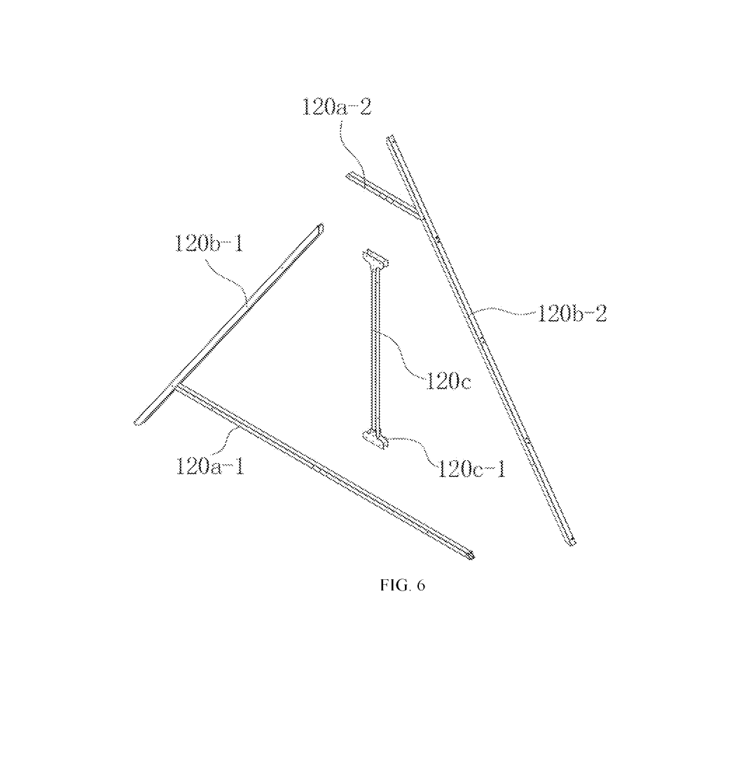

In the present example, referring to FIG. 5-FIG. 6, the fixing beam assembly 120a includes a first fixing beam 120a-1 installed between two inter-column cross beams 110c and a second fixing beam 120a-2 connected to the fixing inclined beam assembly 120b, where the first fixing beam 120a-1 is used to connect and fix the bottoms of the first fixing inclined beam 120b-1 and the second fixing inclined beam 120b-2, and the second fixing beam 120a-2 is used to connect and fix the tops of the first fixing inclined beam 120b-1 and the second fixing inclined beam 120b-2.

Referring to FIG. 5-FIG. 6, the fixing inclined beam assembly 120b includes a first fixing inclined beam 120b-1 and a second fixing inclined beam 120b-2 which are respectively installed on the two sides of each of the first fixing beam 120a-1 and the second fixing beam 120a-2 and are of a splayed structure, where the first fixing inclined beam 120b-1 and the second fixing inclined beam 120b-2 are used to facilitate the installation of photovoltaic panels, and the photovoltaic panels are pre-installed on the first fixing inclined beam 120b-1 and the second fixing inclined beam 120b-2 in advance by using T-bolts.

Referring to FIG. 5-FIG. 6, the two ends of the connecting beam 120c are each provided with a connecting bracket 120c-1 having side walls provided with fixing holes on the side walls. The connecting brackets are used to facilitate fixing and engaging the two ends of the connecting beam 120c to the first fixing beam 120a-1 and the second fixing beam 120a-2 by bolts, and meanwhile, the connecting brackets 120c-1 have a U-shaped structure to facilitate the installation of lifting slings during hoisting.

In the above, the first fixing inclined beam 120b-1 and the second fixing inclined beam 120b-2 have cross-sections of a U-shaped structure, and the first fixing beam 120a-1 and the second fixing beam 120a-2 have square tubular structures. Because there are many fixing assemblies 120 during the installation process of the canopy, which takes up a considerable amount of installation time, the fixing assemblies 120 may be each integrally disassembled into three main parts. One end of the first fixing beam 120a-1 is folded and inserted into the U-shaped slot of the first fixing inclined beam 120b-1, forming one part; one end of the second fixing beam 120a-2 is folded and inserted into the U-shaped slot of the second fixing inclined beam 120b-2, forming one part; and the connecting beam 120c forms one part. Thus, the three main parts may be pre-installed in the factory in advance, shipped in a folded state with a small volume, reducing packaging and transportation costs. During on-site installation, it is only necessary to fold the other end of the first fixing beam 120a-1 and insert it into the U-shaped slot of the second fixing inclined beam 120b-2, fold the other end of the second fixing beam 120a-2 and insert it into the U-shaped slot of the first fixing inclined beam 120b-1 for splaying, and then connect and install the connecting beam 120c to the first fixing beam 120a-1 and the second fixing beam 120a-2, thereby significantly reducing the on-site construction workload of the project.

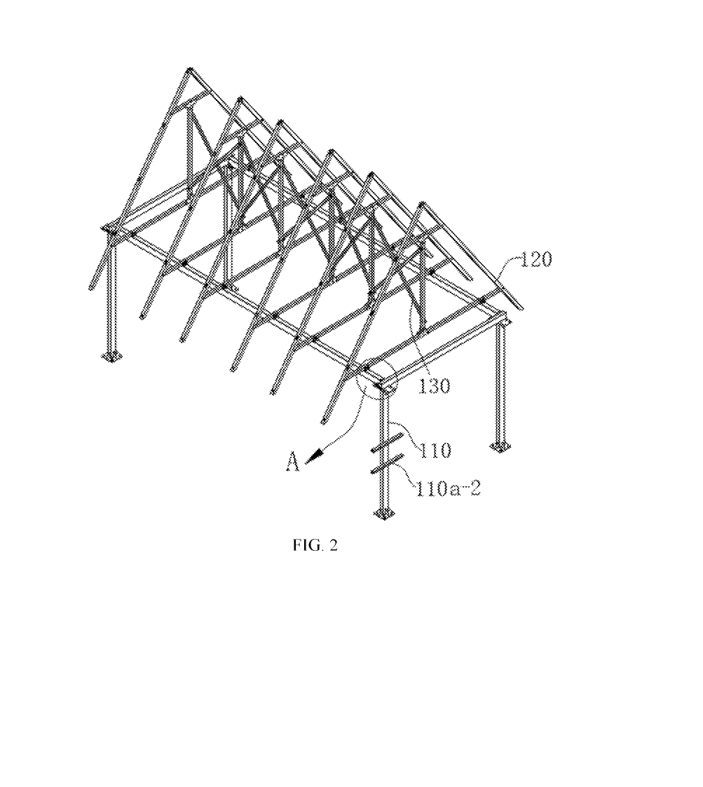

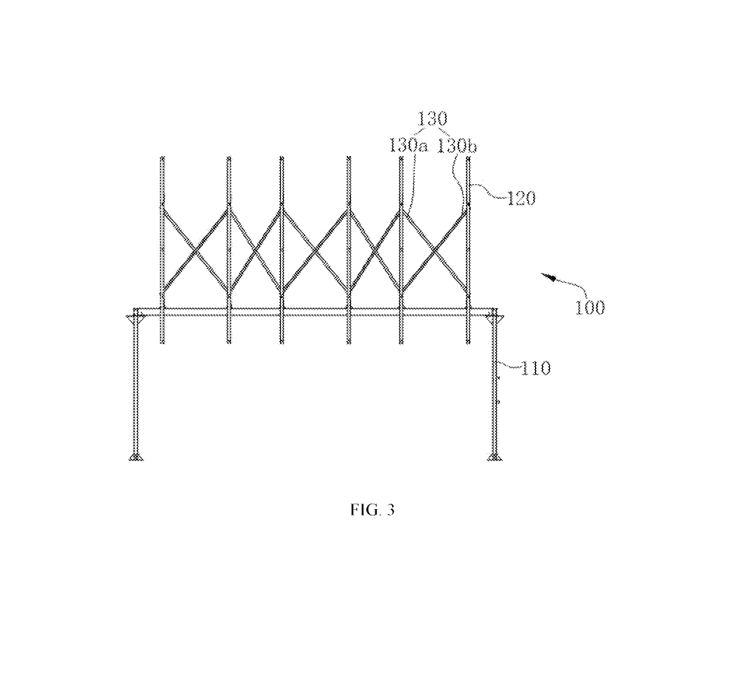

In the present example, referring to FIG. 2-FIG. 3, the supporting and fixing mechanism 100 further includes reinforcing assemblies 130 for reinforcing the multiple fixing assemblies 120, to interconnect and reinforce the multiple fixing assemblies 120, thereby ensuring the structure stability between the multiple fixing assemblies 120.

Referring to FIG. 2-FIG. 3, the reinforcing assembly 130 includes two reinforcing beams 130a installed between two adjacent connecting beams 120c and arranged in a crossed configuration, thereby connecting and reinforcing the two adjacent fixing assemblies 120 through the two reinforcing beams 130a crossing each other.

In the present example, the specific workflow is as follows. When installing the canopy on-site, firstly, the four upright columns 110a are installed at the four corners of the site. Then, two inter-column cross beams 110c and two inter-column longitudinal beams 110b are installed. Simultaneously, the fixing assemblies 120 pre-installed in advance are assembled on-site, and then the photovoltaic panels are pre-installed on the first fixing inclined beams 120b-1 and the second fixing inclined beam 120b-2s respectively. Then, the pre-installed structure of the photovoltaic panels and the corresponding fixing assemblies 120 is hoisted onto the supporting assembly 110 by the manner of hoisting for fixation, thereby reducing the amount of on-site work and reducing on-site construction safety hazards through the manner of pre-installation in advance and hoisting. Meanwhile, traditional canopies are mostly of a single upright column 110a cantilever structure, and excessively large cantilever is prone to overturning, requiring high anti-overturning capacity of the foundation. This canopy uses double upright columns 110a, the fixing inclined beam assembly 120b is arranged symmetrically in a splayed shape, balancing the force distribution and requiring lower anti-overturning capacity of the foundation; the fixing inclined beam assembly 120b and the fixing beam assembly 120a form a triangular structure, the fixing beam assembly 120a and the connecting beam 120c form an I-shaped structure, and there are diagonally crossing reinforcing beams 130a between the connecting beams 120c, ensuring the stability, where the overall stability of the canopy in six directions, front, back, left, right, up, and down, is far superior to that of the single upright column 110a cantilever canopy; and moreover, each assembly may be standardized and customized, simplifying the production, transportation, and installation of parts and components, and enabling rapid delivery.

Furthermore, it is well known that purlins account for the largest proportion of the total steel consumption in the support; the design of eliminating purlins not only significantly reduces the support cost but also imposes lower requirements on the anti-overturning capacity of the foundation, thereby achieving great reduction in the foundation cost.

### Example 3

On the basis of Example 2, referring to FIG. 2, the side wall of one of the upright columns 110a is provided with a mounting bracket 110a-2 for convenient installation and fixing of the inverter 220.

Referring to FIG. 1, the charging and power generation integrated mechanism 200 includes photovoltaic assemblies 210 installed on the first fixing inclined beams 120b-1 and the second fixing inclined beams 120b-2, an inverter 220 installed on the mounting bracket 110a-2 and electrically connected to the photovoltaic assemblies 210, an energy storage cabinet 230 located on one side of the supporting and fixing mechanism 100 and electrically connected to the inverter 220, and charging piles 240 electrically connected to the energy storage cabinet 230 and the inverter 220, where the photovoltaic assemblies 210 are used to convert solar energy to electrical energy after being irradiated by sunlight, the inverter 220 is used to convert the direct current generated by the photovoltaic assemblies 210 to usable alternating current, the energy storage cabinet 230 is used to store the excess electrical energy converted by the inverter 220 and used by the charging piles 240, and the charging piles 240 are used to facilitate vehicle charging.

In the above, each adjacent fixing assemblies 120 and photovoltaic assemblies 210 installed on the two sides thereof constitute a charging parking space 140, and each charging pile 240 corresponds to one or two charging parking spaces 140, thus facilitating the installation of corresponding charging parking spaces 140 and charging piles 240 according to the size of the canopy.

In the present example, the specific workflow is as follows. The photovoltaic assemblies 210 convert solar energy into direct current which is then introduced into the inverter 220, the inverter 220 converts the direct current into alternating current. A portion of the alternating current output by the inverter 220 is output to the charging piles 240 for vehicle charging, and the excess alternating current is output to the energy storage cabinet 230 for storage; and when the weather is bad and the photovoltaic assemblies 210 and the inverter 220 cannot provide enough electric power to the charging piles 240, the stored electric energy in the energy storage cabinet 230 is used to output electric energy to the charging piles 240, thereby ensuring that the charging piles 240 can meet higher charging demands as much as possible.

### Example 4

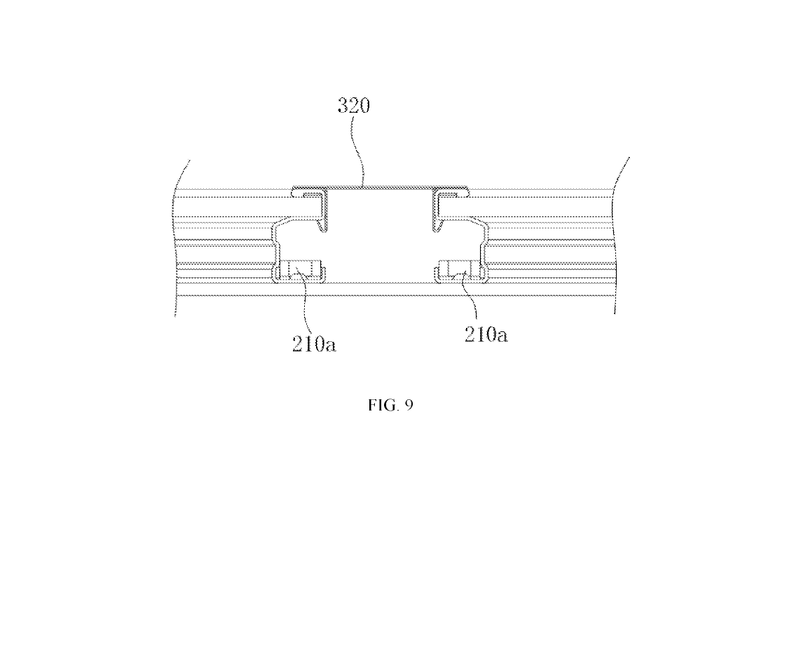

On the basis of Example 3, referring to FIG. 1, FIG. 9, and FIG. 10, it further includes a waterproof diversion mechanism 300, which is used to prevent rainwater from lingering in the gaps between the photovoltaic assemblies 210 and seeping into the photovoltaic assemblies 210 to affect the power generation efficiency of the photovoltaic assemblies 210; and the waterproof diversion mechanism 300 includes a top waterproof plate 310 located on the tops of the photovoltaic assemblies 210 in a splayed structure, transverse waterproof plates 320 installed between two adjacent upper and lower photovoltaic assemblies 210, and longitudinal waterproof plates 330 installed between the two adjacent left and right photovoltaic assemblies 210, where the top waterproof plate 310 is used to prevent rainwater from seeping into the interiors of the photovoltaic panels from the side walls of the topmost photovoltaic assemblies 210, and the transverse waterproof plates 320 and the longitudinal waterproof plates 330 are used to prevent rainwater from seeping into the interiors of the photovoltaic panels through the gaps between the photovoltaic assemblies 210.

In the present example, the transverse and longitudinal gaps of the photovoltaic assemblies 210 are set to be consistent, and the cross-sections of the transverse waterproof plates 320 and the longitudinal waterproof plates 330 are of the same specification, to facilitate the unified specification production of the transverse waterproof plates 320 and the longitudinal waterproof plates 330 and the subsequent assembling thereof with the photovoltaic assemblies 210, the cross-sections of the transverse waterproof plates 320 and the longitudinal waterproof plates 330 are provided with barbed structures adapted to the open cross-sections of the steel frames 210a of the photovoltaic assemblies 210, where the barbed structures are used to be installed in place by simply pressing by hands without bolt fastening, when used in conjunction with the steel frames 210a having the open cross-sections, not only enabling rapid installation but also achieving good waterproof effect.

### Example 5

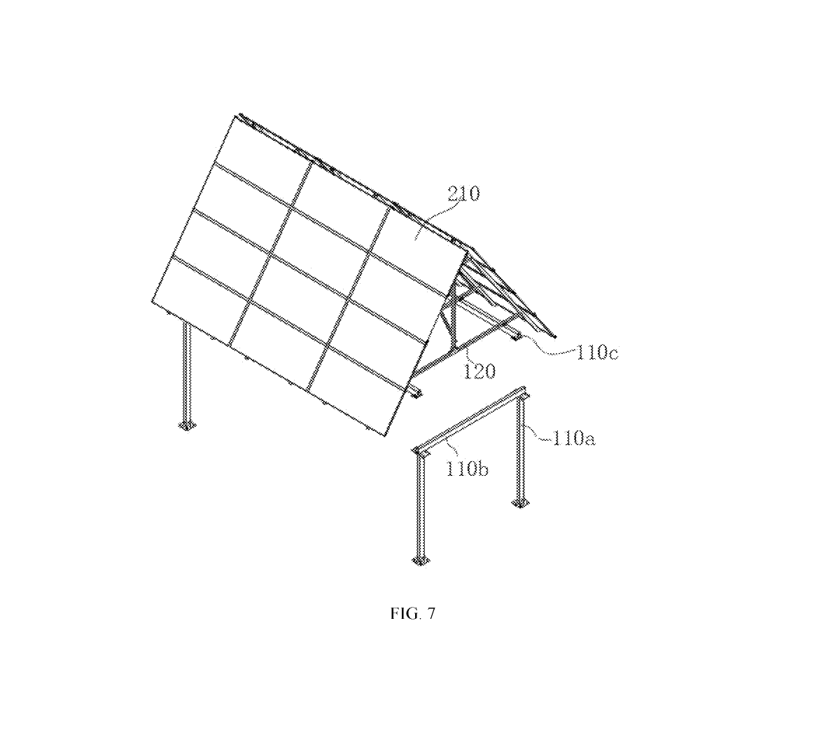

On the basis of Example 4, when the load-bearing capacity at the canopy hoisting site is sufficient and the number of parking spaces is determined, the supporting and fixing mechanism 100 operates in the first hoisting mode. Referring to FIG. 7, after fixing the upright columns 110a at the four corners of the site, it is only necessary to first connect the two inter-column longitudinal beams 110b with the upright columns 110a respectively, then install between the two inter-column cross beams 110c multiple sets of the overall structure with pre-installed photovoltaic assemblies 210 and fixing assemblies 120 respectively, then hoist the whole structure onto the upright columns 110a, and then connect and install the two inter-column cross beams 110c to the upright columns110a, thereby completing the integral hoisting manner.

### Example 6

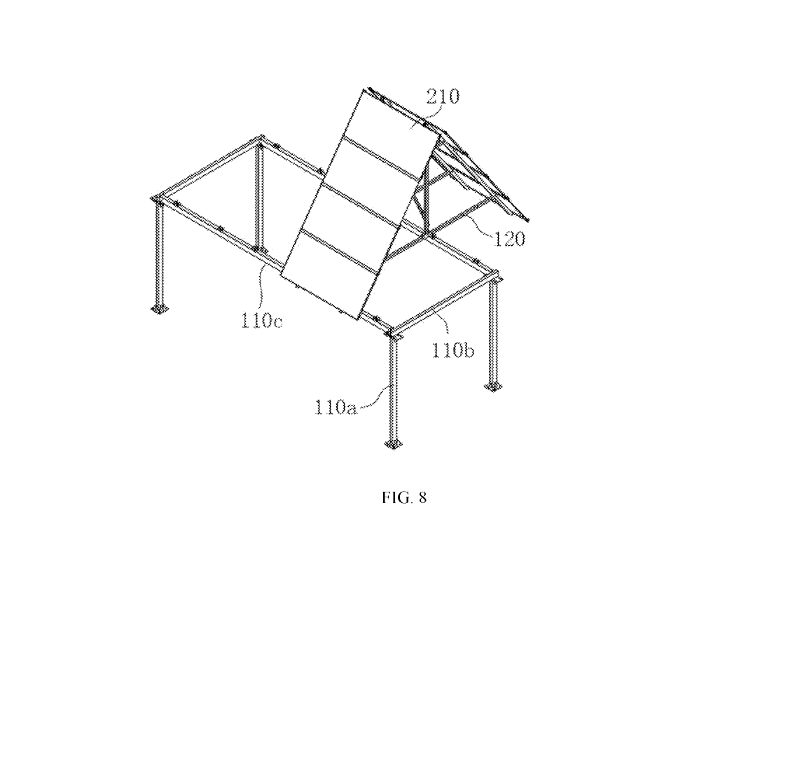

On the basis of Example 5, when the hoisting load-bearing capacity at the canopy site is limited and the integral hoisting cannot be performed, the supporting and fixing mechanism 100 operates in the second hoisting mode. Referring to FIG. 8, the entire supporting assembly 110 is first fixedly installed, multiple partial structures of pre-installed photovoltaic assemblies 210 and fixing assemblies 120 are hoisted onto the supporting assembly 110 and fixedly installed onto the inter-column cross beams 110c, thereby completing the assembly work. This mode is slightly less efficient than the first hoisting mode, but the assembly form is more flexible. Since the canopy adopts the manner of horizontal installation of photovoltaic assemblies 210, one charging parking space 140 corresponds to one photovoltaic assembly 210, and the partial hoisting may be extended indefinitely according to the number of charging parking spaces 140.

Although the present disclosure has been described above with reference to embodiments, various modifications may be made thereto and components may be replaced with equivalents thereof without departing from the scope of the present disclosure. Particularly, as long as there is no structural conflict, all features in the disclosed embodiments of the present disclosure may be combined with each other in any manner for use. The lack of an exhaustive description of these combinations in this specification is merely for the sake of brevity and resource conservation. Therefore, the present disclosure is not limited to the specific embodiments disclosed herein, but includes all technical solutions falling within the scope of the claims.

1. A purlin-less hoisting-type bifacial power-generation integrated canopy, comprising:
a supporting and fixing mechanism, which is of a bifacial splayed structure as a whole to be conveniently hoisted during assembly, wherein the supporting and fixing mechanism has a first hoisting mode for integral hoisting and a second hoisting mode for partial hoisting; and
a charging and power generation integrated mechanism, which is configured to generate electricity by using solar energy during operation and then supply the electricity for vehicle charging, wherein in the first hoisting mode of the supporting and fixing mechanism, photovoltaic panels of the charging and power generation integrated mechanism and a fixing structure on the supporting and fixing mechanism for being pre-assembled with the photovoltaic panels are integrally hoisted; and in the second hoisting mode of the supporting and fixing mechanism, the photovoltaic panels of the charging and power generation integrated mechanism and the fixing structure on the supporting and fixing mechanism for being pre-assembled with the photovoltaic panels are hoisted partially.

2. The purlin-less hoisting-type bifacial power-generation integrated canopy according to claim 1, wherein the supporting and fixing mechanism comprises a supporting assembly and multiple fixing assemblies installed on the supporting assembly and configured for being pre-assembled with the photovoltaic panels.

3. The purlin-less hoisting-type bifacial power-generation integrated canopy according to claim 2, wherein the supporting assembly comprises upright columns fixed at four corners of an installation site, inter-column longitudinal beams each installed between corresponding two front and rear upright columns, and inter-column cross beams each connected between corresponding two left and right upright columns.

4. The purlin-less hoisting-type bifacial power-generation integrated canopy according to claim 3, wherein a top of each of the upright columns is provided with a bearing plate having a top provided with multiple adjustment holes.

5. The purlin-less hoisting-type bifacial power-generation integrated canopy according to claim 3, wherein the fixing assemblies each comprise a fixing beam assembly installed between the two inter-column cross beams, a fixing inclined beam assembly of a splayed structure located on two sides of the fixing beam assembly, and a connecting beam configured for reinforcing the fixing beam assembly.

6. The purlin-less hoisting-type bifacial power-generation integrated canopy according to claim 5, wherein the fixing beam assembly comprises a first fixing beam installed between the two inter-column cross beams and a second fixing beam connected to a fixing inclined beam assembly;
the fixing inclined beam assembly comprises a first fixing inclined beam and a second fixing inclined beam which are respectively installed on two sides of each of the first fixing beam and the second fixing beam and of a splayed structure;
two ends of the connecting beam are each provided with a connecting bracket having side walls provided with fixing holes; and
wherein the first fixing inclined beam and the second fixing inclined beam have cross-sections of a U-shaped structure, and the first fixing beam and the second fixing beam are each of a square tubular structure.

7. The purlin-less hoisting-type bifacial power-generation integrated canopy according to claim 6, wherein the supporting and fixing mechanism further comprises reinforcing assemblies configured for reinforcing the multiple fixing assemblies; and
the reinforcing assemblies each comprises two reinforcing beams installed between two adjacent connecting beams and arranged in a crossed configuration.

8. The purlin-less hoisting-type bifacial power-generation integrated canopy according to claim 6, wherein a side wall of one of the upright columns is provided with a mounting bracket;
the charging and power generation integrated mechanism comprises photovoltaic assemblies installed on the first fixing inclined beams and the second fixing inclined beams, an inverter installed on the mounting bracket and electrically connected to the photovoltaic assemblies, an energy storage cabinet located on one side of the supporting and fixing mechanism and electrically connected to the inverter, and charging piles electrically connected to the energy storage cabinet and the inverter; and
wherein each two adjacent fixing assemblies and photovoltaic assemblies installed on two sides thereof constitute a charging parking space, and each of the charging piles corresponds to one or two charging parking spaces.

9. The purlin-less hoisting-type bifacial power-generation integrated canopy according to claim 6, further comprising a waterproof diversion mechanism, wherein the waterproof diversion mechanism comprises a top waterproof plate located on tops of the photovoltaic assemblies in the splayed structure, transverse waterproof plates each installed between corresponding two adjacent upper and lower photovoltaic assemblies, and longitudinal waterproof plates each installed between corresponding two adjacent left and right photovoltaic assemblies.

10. The purlin-less hoisting-type bifacial power-generation integrated canopy according to claim 9, wherein transverse and longitudinal gaps of the photovoltaic assemblies are set to be consistent, cross-sections of the transverse waterproof plates and the longitudinal waterproof plates are of a same specification, and the cross-sections of the transverse waterproof plates and the longitudinal waterproof plates are provided with barbed structures adapted to open cross-sections of steel frames of the photovoltaic assemblies.
